(19) United States
(12) Patent Application Publication
(10) Pub. No.: US 2011/0222302 A1
(43) Pub. Date: Sep. 15, 2011

(54) LIGHTING SYSTEM

(75) Inventors: Thomas S. Hodgson, Holland, MI (US); Randy L. Arendsen, Zeeland, MI (US); Steven M. Spoerre, Holland, MI (US); Robert L. Hamelink, Hamilton, MI (US); Kathleen M. Pacheco, Thiensville, WI (US)

(73) Assignee: Johnson Controls Technology Company

(21) Appl. No.: 12/672,145

(22) PCT Filed: Jul. 25, 2008
(86) PCT No.: PCT/US08/71177

§ 371 Date: May 26, 2011

Related U.S. Application Data
(60) Provisional application No. 60/963,685, filed on Aug. 7, 2007.

(51) Int. Cl. B60Q 1/26; F21L 4/00

(52) U.S. Cl. 362/490; 362/157; 362/459

(57) ABSTRACT

Lighting systems for a vehicle are disclosed that can include a removable power source, a touch activation system, tasked lighting and a directional lighting system. The lighting systems, can be used, for example, to illuminate the interior of a vehicle.

### CROSS-REFERENCE TO RELATED PATENT APPLICATIONS

This application claims priority to and the benefit of U.S. Provisional Application Ser. No. 60/963,685 entitled “Lighting Systems for Vehicle Lighting” filed Aug. 7, 2007, the disclosure of which is hereby incorporated by reference in its entirety.

### BACKGROUND

The following background is provided simply as an aid in understanding the disclosed systems and devices and is not admitted to describe or constitute prior art.

The present disclosure is generally related to lighting systems. The lighting systems can be used, for example, for various vehicles such as, but not limited to automobiles, trains, aircraft, boats, etc. Specifically, the disclosed systems and devices can be used in the interior of a vehicle in locations such as an overhead console or a rear lamp assembly.

### SUMMARY

According to an exemplary embodiment, a lighting device for a vehicle includes a console having a light source and a removable power source electrically connected to the light source.

According to an exemplary embodiment, an overhead console for a vehicle includes a light source and a removable power source electrically connected to the light source.

According to an exemplary embodiment, a rear lamp for a vehicle includes a light source and a removable power source, electrically connected to the light source.

According to an exemplary embodiment, a lighting device for a vehicle includes a light source and a touch-sensitive control circuit, electrically connected to the light source, for controlling the light source.

According to an exemplary embodiment, an overhead console for a vehicle includes a light source and a touch-sensitive control circuit, electrically connected to the light source, for controlling the light source.

According to an exemplary embodiment, a rear lamp for a vehicle includes a light source and a touch-sensitive control circuit, electrically connected to the light source, for controlling the light source.

According to an exemplary embodiment, a lighting device for a vehicle includes a housing, a light source attached to the housing and a lens positioned at an end of the housing, wherein the housing, light source and lens are located above a headliner of a vehicle interior.

According to an exemplary embodiment, a lighting device for a vehicle includes a light source and a light-directing device for directing light emitted from the light source.

According to an exemplary embodiment, an overhead console for a vehicle includes a light source and a light-directing device for directing light from the light source.

According to an exemplary embodiment, a rear lamp for a vehicle includes a light source and a light-directing device for directing light from the light source.

It is to be understood that both the foregoing general description and the following detailed description are exemplary and explanatory only. These and other features, aspects and advantages will become apparent from the following description and the accompanying exemplary embodiments shown in the drawings, which are briefly described below.

### BRIEF DESCRIPTION OF THE DRAWINGS

FIG. 1 is an isometric view of an embodiment of a vehicle including an overhead console and a rear lamp.

FIG. 2 shows an isometric view of an embodiment of a lighting system including a detachable power source.

FIG. 3 shows an exploded view of an embodiment of a touch activation type lighting system.

FIG. 4 shows an isometric view of an embodiment of a vehicle including one or more overhead lamps.

FIG. 5(a) is an exploded view of an embodiment of an overhead lamp.

FIG. 5(b) is a partial sectional view of one embodiment of a lens/bezel assembly for the overhead lamp of FIG. 5(a).

FIG. 5(c) is a partial sectional view of one embodiment of a lens/bezel assembly for the overhead lamp of FIG. 5(a).

FIG. 6(a) is an embodiment of a directional lighting system.

FIG. 6(b) is a block diagram of the major components of the lighting system of FIG. 6(a).

FIG. 7 illustrates an embodiment of directed light in the interior of a vehicle.

### DETAILED DESCRIPTION

It is to be understood that both the foregoing general description and the following detailed description are exemplary and explanatory only. Features, aspects and advantages of the lighting systems will become apparent from the following description and the accompanying exemplary embodiments shown in the drawings, which are briefly described below. It should be understood that the following description is intended to describe exemplary embodiments, and not to limit the disclosed lighting systems.

Referring in general to the FIGURES, lighting systems are shown according to several exemplary embodiments. The lighting systems can be used for vehicle applications, for example, in the interior of the vehicle in locations such as an overhead console or a rear lamp or as part of the exterior of the vehicle.

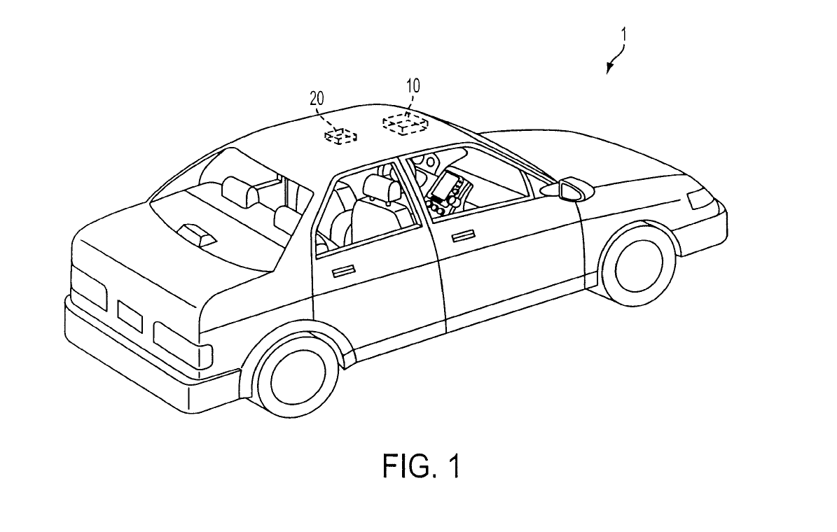

FIG. 1 is an isometric view of a vehicle 1 with an overhead console 10 and a overhead lamp 20, showing one exemplary placement of the overhead console 10 and the overhead lamp 20. The overhead console 10 is located in the interior of the vehicle 1, generally on the roof between the two front seats. In an exemplary embodiment, the overhead lamp 20 acts as a rear lamp and is provided rearward of the overhead console 10 at a location generally over the rear seats.

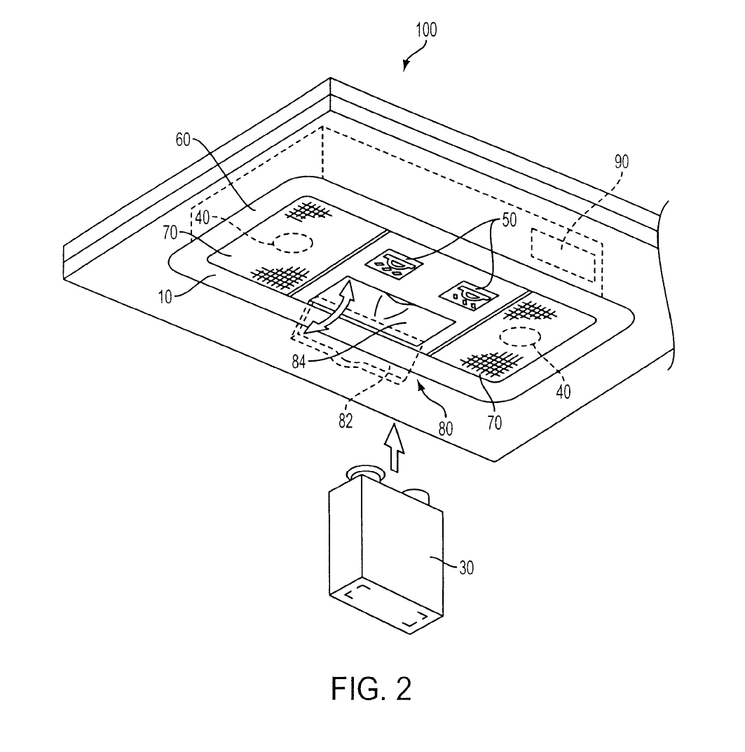

FIG. 2 shows a removable power source lighting system 100. An isometric view of an overhead console 10 according to an exemplary embodiment is shown. The overhead console 10 is powered by a removable power source 30 such as, for example, a battery. The overhead console 10 includes one or more light sources 40, one or more buttons 50 to toggle the light sources 40 on and off, an outer bezel 60, one or more lenses 70 to focus and/or direct the light emitted by the light sources 40, and a chamber 80 for holding the removable power source 30. The light sources 40 may include LEDs or incandescent bulbs, for example, that produce a light output ranging from bright white to soft yellow or other color options.

The light sources 40 are electrically coupled to a removable power source 30. According to one exemplary embodiment, the removable power source 30 is received by the chamber 80 provided in the overhead console 10. The chamber 80 is accessible through a door or cover 82. The chamber 80 may include a docking station 84 for returning the removable power source 30 and for electrically coupling the removable power source 30 to the light sources 40. According to another exemplary embodiment, the removable power source 30 is connected to the overhead console 10 such that it is not accessible via an access door 82. Instead, the entire overhead console 10 may be detached from the vehicle 1 to access the removable power source 30. This alternative configuration allows a removable power source 30 to be used in those situations when the console design does not permit the inclusion of an access door 82 or the aesthetic design features will not permit an access door to be located on a visible surface of the overhead console 10.

According to one embodiment, the lighting system 100 includes a warning circuit 90. The warning circuit 90 monitors the amount of energy currently stored in the removable power source 30 and signals an occupant/owner of the vehicle 1 when the power capacity of the removable power source 30 is relatively low. As a result, the removable power source 30 may be replaced prior to failure. According to one embodiment, the warning circuit also provides a signal to the occupant/owner if the removable power source 30 is functioning normally (e.g., a green blinking light). According to alternative embodiments, the signal may be an audible “chirp” or a visual “blink.”

According to various exemplary embodiments, the removable power source 30 may be one or more alkaline batteries, nickel metal-hydride batteries, lithium-ion batteries, capacitors (e.g., carbon nanotube capacitors) or any other suitable removable/portable power source. While a single removable power source 30 is shown in FIG. 2, it should be understood that the number and type of power sources 30 may vary according to the power requirements and/or space constraints of the lighting system 100 or surrounding vehicle component. The lighting system 100 may also be employed on the exterior of a vehicle, for example, at locations near exterior door handles or near cargo space.

The removable power source 30 provides a replaceable power source for the light sources 40 that can be removed from the vehicle's electrical system. This lighting system 100 may be employed in consoles, rear lamps, or other vehicle components, including components that are located in areas where it would be difficult and/or costly to include a wire harness to electrically couple the lights to the electrical system of the vehicle 1. The lighting system 100 described above and shown in FIG. 2 eliminates the need for such a wire harness.

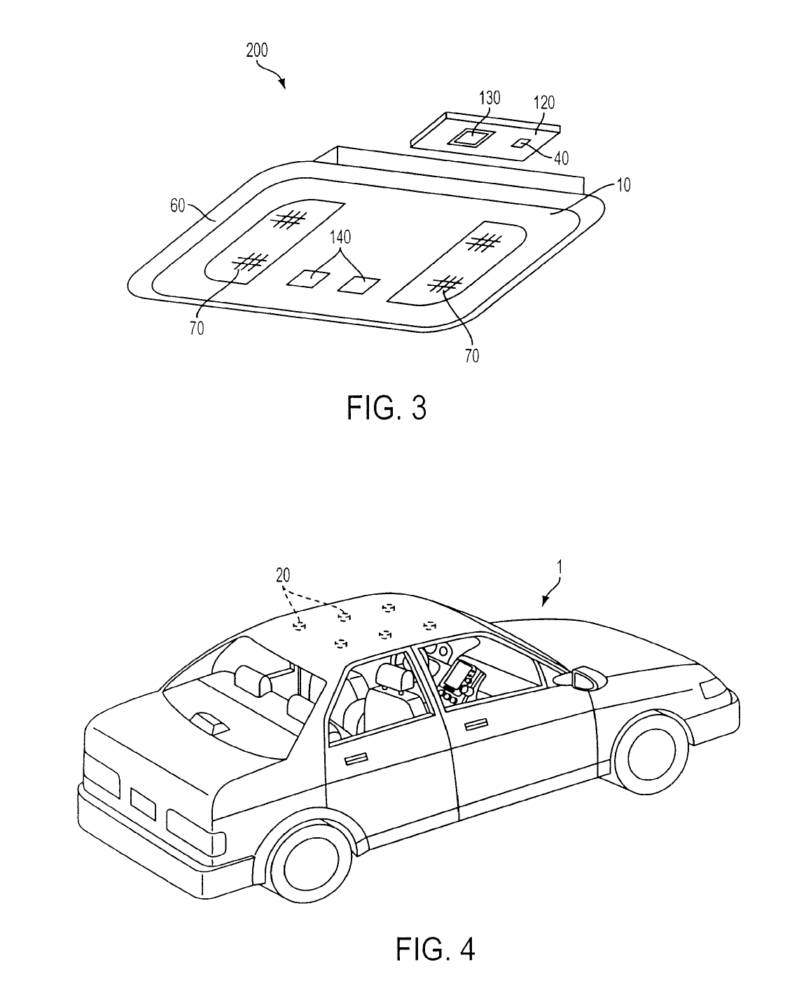

FIG. 3 illustrates a touch activation lighting system 200. FIG. 3 shows an exploded view of an overhead console 10 according to another exemplary embodiment. The overhead console 10 includes one or more light sources 40, one or more exterior surfaces 140 for toggling the light sources 40 on and off, an outer bezel 60, one or more lenses 70 and a touch-sensitive control circuit 130 for controlling the light source 40. According to one embodiment, the light source 40 is shown in FIG. 3 as an LED 40 coupled to a printed circuit board (PCB) 120. The PCB 120 also includes a touch-sensitive control circuit 130 for the light source 40. According to an exemplary embodiment, the touch-sensitive control circuit 130 is implemented by any one of a capacitive touch switch or a field effect switch. The touch-sensitive control circuit 130 repeatedly charges and discharges the exterior surface 140. When a user touches the exterior surface 140, the change in capacitance due to the presence of the user is sensed by the touch-sensitive control circuit 130, causing the touch-sensitive control circuit 130 to activate the light source 40. Accordingly, instead of pressing a button, an occupant may touch the exterior surface 140 of the touch-sensitive control circuit 130 to activate the lights 40.

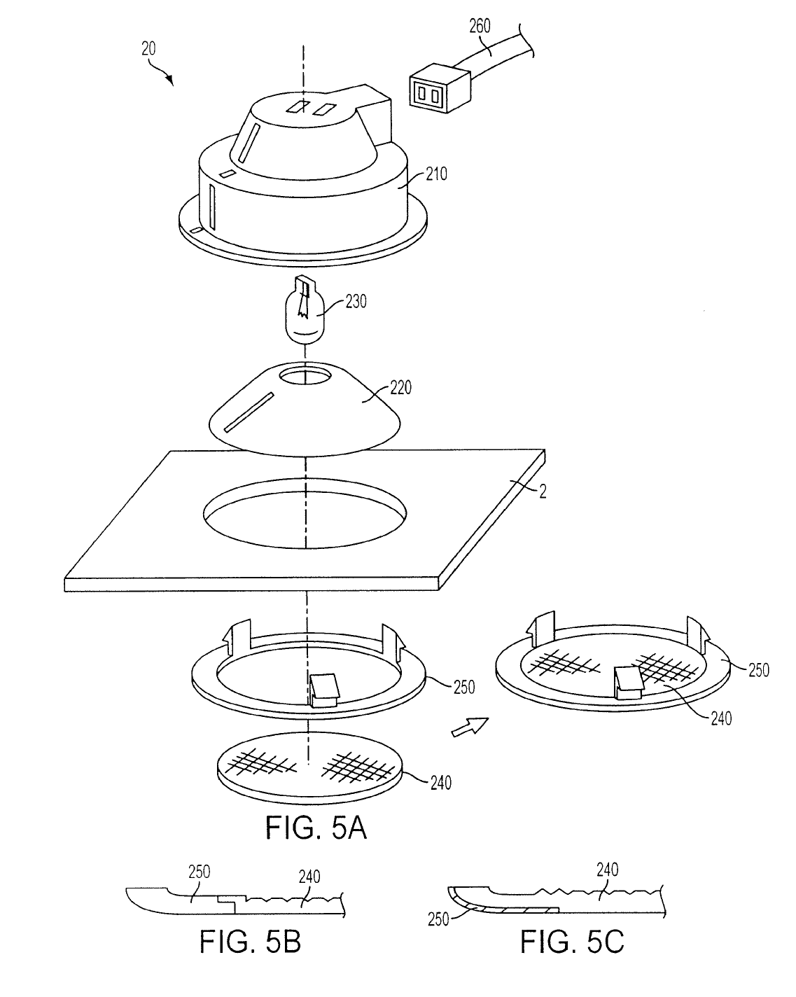

FIG. 4 shows an isometric view of a vehicle 1 including one or more overhead lamps 20 according to an exemplary embodiment. The overhead lamps 20 may be provided at various locations in the headliner 2 of the vehicle 1 including, for example at locations to provide task lighting in the interior of the vehicle 1. As shown in FIG. 5(a), the overhead lamp 20 is similar to a recessed light or can light, and includes a housing 210, a reflector 220, a light source 230 (e.g., bulb, LED), a lens 240, and a bezel or trim piece 250. The housing 210 is provided above the headliner 2 of the vehicle 1, may be cylindrical in shape, and includes a socket that receives the light source 230. According to the embodiment shown in FIG. 5, electrical power is supplied to the lamp 20 via a wire harness 260 connected to the housing 210.

According to one exemplary embodiment shown in FIG. 5(a), the light source 230 is an incandescent bulb. According to other exemplary embodiments, the light source 230 may be an LED or any other suitable light source, and the housing 210 may be adapted to receive these light sources 230. A reflector 220 at least partially surrounds the bulb 230 and may be mounted in the housing 210. The reflector 220 is a reflective member that helps to direct the light from the light source 230 out of the housing 210 and into the interior of the vehicle 1. A lens 240 is provided at the open end of the housing 210 to diffuse and or concentrate the light produced by the bulb 230. The bezel 250 is a generally annular body that surrounds the lens 240 and acts as a trim piece for the overhead lamp 20. According to one embodiment, the bezel 250 includes clips or other coupling members that couple the bezel 250 to the housing 210.

According to one exemplary embodiment, the lens 240 and the bezel 250 are provided as separate components, and the lens 240 is positioned between the bezel 250 and the housing 210 and/or the headliner 2 of the vehicle 1. According to another exemplary embodiment as shown in FIG. 5(b), the lens 240 and the bezel 250 may be formed as a single component with a two-shot injection molding process or another suitable process. According to still another exemplary embodiment as shown in FIG. 5(c), the lens 240 may be coupled to the housing 210, and the bezel 250 may be a film or laminate that is applied to the lens 240 before or after the lens 240 is mounted to the overhead lamp assembly. In this embodiment, the bezel film 250 may include plastic which is molded behind the film. The bezel film 250 may include decorative designs and patterns such as, for example, wood grain, printed graphic, etc.

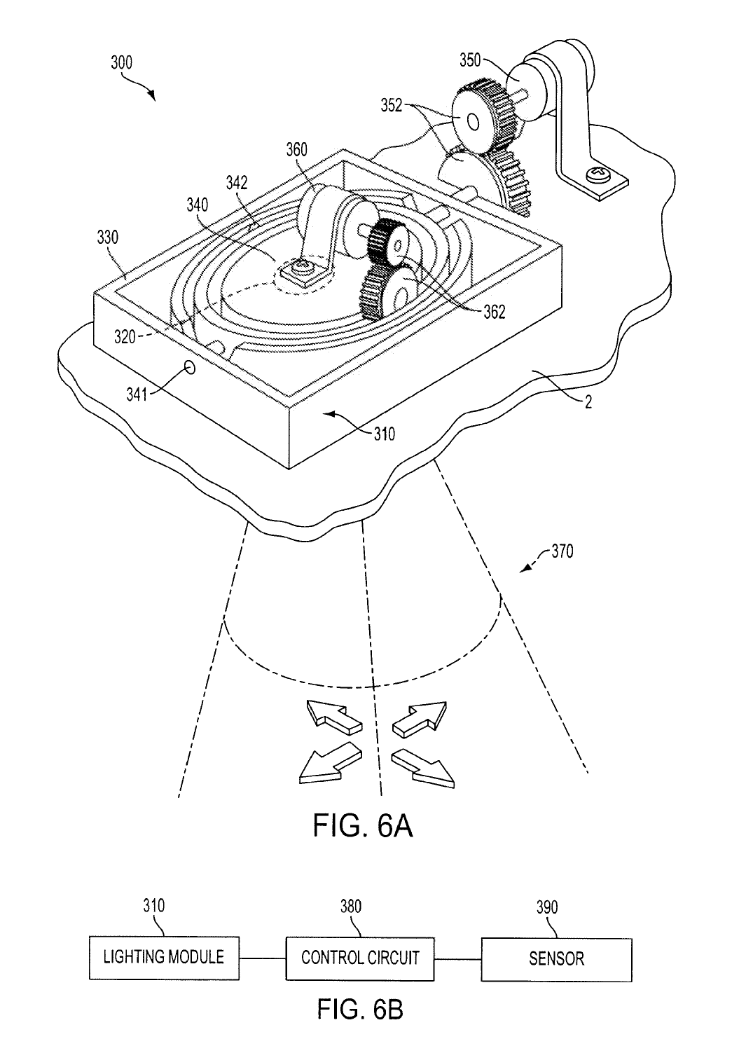

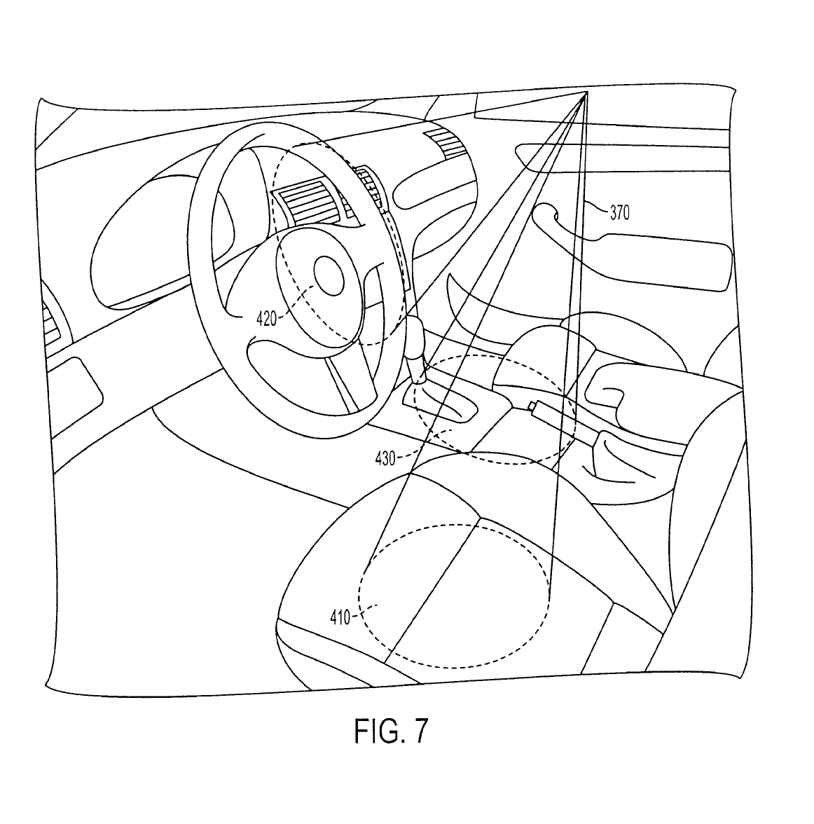

FIG. 6(a) illustrates a directional lighting system 300 according to another exemplary embodiment. The directional lighting system 300 is configured to aim or direct light 370 in order to illuminate a variety of areas. FIG. 7 shows interior areas of a vehicle 1 being illuminated with the directional lighting system 300. According to an exemplary embodiment, the directional lighting system 300 includes a light module 310 with a light source 320 (positioned underneath the light-directing device 340), a frame 330, and a light-directing device 340 mounted to the frame 330. The light-directing device 340 may be pivotally mounted to the frame 330 to allow the light source 320 to pivot relative to the frame 330 about a first axis 341 and/or a second axis 342.

According to an exemplary embodiment, a first motor 350 may be coupled to the vehicle 1 (e.g., the headliner 2) or the frame 330 to rotate the light-directing device 340 about a first axis 341 using a first motion transmission device 352, and a second motor 360 is coupled to the light-directing device 340 itself to rotate the light source 320 about a second axis 342 using a second motion transmission device 362. The second axis 342 may be perpendicular to the first axis 341. According to one embodiment the first and second motion transmission device 352, 362 may be a gear set, a belt drive, a rack and pinion device, a cable driven device or any other device for transmitting motion.

The light source 320 may be configured to provide a column of more concentrated focused light 370. Because the directional lighting system 300 can pivot the light source 320 about the first axis 341 and second axis 342, the concentrated focused light 370 may cover a wider range of areas. For example, as shown in FIG. 7, the light source 320 may be directed at the floor, the seat 410, at the steering wheel 420 (e.g., directed near the ignition), or at the center console 430. According to one embodiment, the light 370 may be directed manually by the vehicle occupant. Alternatively, as shown in FIG. 6(b), the lighting module 310 may be controlled by a control circuit 380 to follow a preprogrammed path. As another alternative, the lighting module 310 may be controlled by the control circuit using input from sensors 390 (e.g., motion sensor, temperature sensor, infra red sensor, etc.) to highlight various portions of the interior of the vehicle 1. The sensor 390 is operably connected to the control circuit 380, i.e., via wires or wirelessly. Accordingly, the light 370 can be directed to various areas of the vehicle based on the presence and location of a vehicle occupant, occupant movement, etc.

One or more of the lighting systems disclosed in the figures can be used as courtesy lamps (e.g. when a user opens a door, uses a remote keyless entry (RKE) system to unlock doors, etc.), dome lamps, vanity lights, courtesy lights in various locations in the vehicle (e.g. to illuminate coat hooks provided above the doors, etc.), or as accent or mood lighting.

The lighting systems discussed above may be part of an overhead console 10. The overhead console 10 may include a wireless control system, a vehicle compass display, a temperature display, a trip computer display, a wireless communication system (e.g., a Bluetooth transmitter) and/or a hands-free phone system microphone. The overhead console 10 also may include a variety of activation devices (e.g., buttons, non-contact switching, remote switching, etc.) that are configured for controlling a variety of components including overhead task lights (e.g., map lights, etc.), the interior lights, sunroofs, and/or short range radio communication equipment (e.g., Bluetooth®, Homelink® wireless control systems (WCS), etc.).

An overhead console 10 may be configured to provide illumination in response to a courtesy function from a vehicle. The overhead console 10 may provide the illumination from a light source configured to be a map lamp and/or a light source configured to be a cabin illuminating lamp.

The LED light sources described above can be white light-emitting LEDs or LEDs that emit other colors of light, such as blue, green or red.

It is important to note that the construction and arrangement of the lighting systems as shown in the various exemplary embodiments is illustrative only. Although only a few embodiments of the present systems have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described in the application. For example, elements shown as integrally formed may be constructed of multiple parts or elements, the position of elements may be reversed or otherwise varied, and the nature of number of discrete elements or positions may be altered or varied. Accordingly, all such modifications are intended to be included within the scope of the subject matter described in the application. The order or sequence of any process or method steps may be varied or re-sequenced according to alternative embodiments. Other substitutions, modifications, changes and omissions may be made in the design, operating conditions and arrangement of the exemplary embodiments.

This application incorporates by reference the entire disclosures of PCT Application No. PCT/US2008/057,954 entitled “Light Devices” filed Mar. 21, 2008, U.S. Provisional Application No. 60/924,046 entitled “LED Vehicle Lighting” filed Apr. 27, 2007, U.S. Provisional Application No. 60/919,485 entitled “Light Assembly for Vehicle” filed Mar. 22, 2007, and U.S. Provisional Application No. 60/929,459 entitled “LED Vehicle Lighting” filed Jun. 28, 2007. The various light sources and lighting systems disclosed in the aforementioned applications may be used in the lighting systems disclosed and described herein.

What is claimed is:

1. A lighting device for a vehicle, comprising:
a console, having a light source;
and a removable power source, electrically connected to the light source.

2. The lighting device as claimed in claim 1, wherein the removable power source is a battery.

3. The lighting device as claimed in claim 1, wherein the console is configured to attach to a surface of a vehicle.

4. The lighting device as claimed in claim 1, wherein the light source is an LED or an incandescent bulb.

5. The lighting device as claimed in claim 1, further comprising a circuit for monitoring an amount of energy in the removable power source and producing a signal indicating the amount of energy stored in the removable power source.

6. The lighting device as claimed in claim 1, further comprising:
a button for toggling the light source on and off;
a lens for directing light emitted by the light source; and
a chamber, for housing the removable power source.

7. The lighting device as claimed in claim 6, wherein the chamber is provided in the console and includes a docking station for electrically connecting the removable power source to the light source.

8. The lighting device as claimed in claim 6, wherein the chamber is accessed via a door positioned on an outer surface of the console.

9. An overhead console for the interior of a vehicle, comprising:
a light source; and
a removable power source, electrically connected to the light source.

10. A rear lamp for the interior of a vehicle, comprising:
a light source; and
a removable power source, electrically connected to the light source.

11. A lighting device for a vehicle, comprising:
a light source; and
a touch-sensitive control circuit, electrically connected to the light source, for controlling the light source.

12. The lighting device as claimed in claim 11, wherein the light source is a LED.

13. The lighting device as claimed in claim 11, further comprising:
an exterior surface for toggling the light source on and off; and
a lens for directing light emitted by the light source.

14. The lighting device as claimed in claim 11, wherein the light source and the touch-sensitive control circuit are coupled to a printed circuit board (PCB).

15. The lighting device as claimed in claim 11, wherein the touch-sensitive control circuit is a capacitive touch switch.

16. The lighting device as claimed in claim 11, wherein the touch-sensitive control circuit is a field effect switch.

17. The lighting device as claimed in claim 11, wherein the exterior surface is configured to sense physical contact.

18. The lighting device as claimed in claim 17, wherein the exterior surface is repeatedly charged and discharged to detect a change in capacitance.

19. An overhead console for a vehicle interior, comprising:
a light source; and
a touch-sensitive control circuit, electrically connected to the light source, for controlling the light source.

20. A rear lamp for a vehicle interior, comprising:
a light source; and
a touch-sensitive control circuit, electrically connected to the light source, for controlling the light source.

21. A lighting device for a vehicle interior, comprising:
a housing;
a light source attached to the housing; and
a lens positioned at an end of the housing, wherein the housing, light source and lens are located above a headliner of the vehicle.

22. The lighting device as claimed in claim 21, wherein the light source is an incandescent bulb.

23. The lighting device as claimed in claim 21, wherein the light source is a LED.

24. The lighting device as claimed in claim 21, wherein the lens is a diffuser lens.

25. The lighting device as claimed in claim 21, wherein the lens is a concentrator lens.

26. The lighting device as claimed in claim 21, further comprising:
a reflector at least partially surrounding the light source; and
a bezel attached to the housing for holding the lens in place.

27. The lighting device as claimed in claim 22, wherein the lens and the bezel are formed as a single component.

28. The lighting device as claimed in claim 22, wherein the bezel is a film applied to the lens.

29. A lighting device for a vehicle, comprising:
a light source; and
a light-directing device for directing light emitted from the light source.

30. The lighting device as claimed in claim 29, wherein the light source is an LED.

31. The lighting device as claimed in claim 29, wherein the light-directing device is manually controlled.

32. The lighting device as claimed in claim 29, further comprising a control circuit for controlling the movement of the light-directing device so that light emitted from the light source is projected in a preprogrammed path.

33. The lighting device as claimed in claim 32, further comprising a sensor, wherein the control circuit controls the movement of the light-directing device in response to input from the sensor.

34. The lighting device as claimed in claim 29, further comprising a lighting module, having a frame, for housing the light source and the light-directing device, wherein the light-directing device is pivotally mounted to the frame about at least one axis.

35. The lighting device of claim 34, further comprising:
a motion transmission device connected to the at least one axis; and
a motor connected to the motion transmission device for causing the motion transmission device to rotate the light-directing device about the at least one axis.

36. The lighting device as claimed in claim 34, wherein the light-directing device is pivotally mounted to the frame about two axes.

37. The lighting device of claim 36, wherein a first axis is perpendicular to a second axis.

38. The lighting device of claim 37, further comprising:
a first motion transmission device connected to the first axis;
a second motion transmission device connected to the second axis;
a first motor connected to the first motion transmission device for causing the first motion transmission device to rotate the light-directing device about the first axis; and
a second motor connected to the second motion transmission device for causing the second motion transmission device to rotate the light-directing device about the second axis.

39. An overhead console for a vehicle interior, comprising:
a light source; and
a light-directing device for directing light from the light source.

40. A rear lamp for a vehicle interior, comprising:
a light source; and
a light-directing device for directing light from the light source.
